(19) United States
(12) Patent Application Publication
(10) Pub. No.: US 2017/0022930 A1
(43) Pub. Date: Jan. 26, 2017

(54) Production Device for Piston for Internal-Combustion Engine, and Production Method Using Production Device for Piston for Internal-Combustion Engine

(71) Applicant: Hitachi Automotive Systems, Ltd., Hitachinaka-shi, Ibaraki (JP)

(72) Inventor: Norikazu Takahashi, Yokohama-shi, Kanagawa (JP)

(21) Appl. No.: 15/125,057

(22) PCT Filed: Dec. 25, 2014
(86) PCT No.: PCT/JP2014/084266

§ 371 Date: Sep. 9, 2016

(30) Foreign Application Priority Data
Mar. 13, 2014 (JP) 2014-049566

(51) Int. Cl. F02F 3/28; F16J 1/00; B22D 17/24; B22C 9/06; B22D 15/02; B22D 17/00; F16J 9/22; B22C 9/24

(52) U.S. Cl. CPC F02F 3/28; F16J 9/22; F16J 1/001; B22C 9/24; B22C 9/06; B22D 15/02; B22D 17/002; B22D 17/24; F02F 2003/0007

(57) ABSTRACT

The present invention provides piston production device and piston production method capable of surely holding friction-resistant ring regardless of presence or absence of decrease in accuracy of outside diameter of holding pin. Device has lower mold provided thereinside with cavity for forming piston and having opening, upper mold provided movably to open/close opening of cavity, and three holding pins rotatably supported by holding holes of upper mold and having top end portions protruding from lower surface of upper mold. Top end portions have flat holding surfaces formed by cutting tip end sides of top end portions in half from tip end edges along axial direction and stepped surfaces formed from upper ends of holding surfaces toward radial direction. By rotating holding pins in synchronization with each other in the same direction, friction-resistant ring is held by three points of holding surfaces.

### TECHNICAL FIELD

The present invention relates to a production device of a piston for an internal combustion engine, which is formed by casting, and also relates to a piston production method using the production device.

### BACKGROUND ART

As is known, regarding a piston for a diesel engine, to respond to a request for weight reduction, base material of the piston is formed by aluminium alloy material. Although a piston ring groove is formed on an outer periphery of a crown portion located at an upper end of the piston and a piston ring is directly provided here in the same manner as a piston for a gasoline engine, since a combustion pressure acting on the crown portion is high, there is a risk that the piston ring groove will be damaged. Because of this, a cast-iron-made friction-resistant ring is buried or embedded in the crown portion, and the piston ring groove is formed on an outer circumference of this high-strength friction-resistant ring.

As a production device of the piston having the friction-resistant ring, it has been disclosed in the following Patent Document 1. When briefly outlining the piston production device, the piston production device has a lower mold having thereinside a cavity for forming the piston and an upper mold opening and closing a cavity opening of the lower mold. While the upper mold is provided with one holding pin that holds the friction-resistant ring from a radially outer side, the friction-resistant ring is provided, at a flange portion located at an outer circumferential portion of the friction-resistant ring, with a holding hole into and with which a top end of the holding pin is inserted and engaged. Further, positioning of the friction-resistant ring in a radial direction is made by three positioning pins that are provided at the upper mold so as to extend downwards in the same manner as the holding pin.

### CITATION LIST

### Patent Document

Patent Document 1: Japanese Unexamined Patent Publication No. JP2011-001889

### SUMMARY OF THE INVENTION

### Technical Problem

In the related art piston production device, however, since the friction-resistant ring is held by the one holding pin provided at the upper mold being inserted into and engaged with the holding hole of the friction-resistant ring, if accuracy of an outside diameter of the holding pin and/or an inside diameter of the holding hole is decreased, there is a possibility that the friction-resistant ring will incline with the holding pin being a center or fall off due to poor engagement, then the holding of the friction-resistant ring might become unstable.

The present invention was made in view of the above technical problem occurring in the related art piston production device. An object of the present invention is therefore to provide a piston production device and a piston production method which are capable of surely holding the friction-resistant ring regardless of the presence or absence of decrease in the accuracy of the outside diameter of the holding pin.

### Solution to Problem

As an invention recited in claim 1, a production device of a piston for an internal combustion engine, the piston having a friction-resistant ring embedded in a crown portion of the piston for forming a piston ring groove, the production device comprises: a main mold provided thereinside with a cavity for forming the piston and having an opening of the cavity at an end portion of the cavity; a movable mold provided movably so as to open and close the opening of the cavity; and a plurality of holding pins whose top end portions protruding from the movable mold are inserted and disposed in the cavity and can hold the friction-resistant ring. And, at least one of the plurality of holding pins is provided rotatably on an axis of the one of the holding pins with respect to the movable mold, and the one of the holding pins has at a top end portion thereof a holding portion that contacts and holds the friction-resistant ring by a rotation angle position of the one of the holding pins.

### Effects of Invention

According to the present invention, since the friction-resistant ring can be held only by rotating, by a predetermined angle, the holding pin supported by the movable mold, it is possible to hold the friction-resistant ring regardless of the presence or absence of decrease in the accuracy of the outside diameter of the holding pin. Therefore, stable holding of the friction-resistant ring by the holding pin can be obtained.

### BRIEF DESCRIPTION OF THE DRAWINGS

FIG. 1 is a longitudinal cross section of a piston for a diesel engine after casting and machining, according to the present invention.

FIG. 2 is a drawing schematically showing a longitudinal cross section of a casting device (a production device).

FIG. 3 is a drawing showing a longitudinal cross section of the casting device in an early stage of operation.

FIG. 4 is a drawing showing a longitudinal cross section of the casting device with a friction-resistant ring held at an upper mold.

FIG. 5 is a drawing showing a longitudinal cross section of the casting device with the upper mold moved down and with positioning of the friction-resistant ring being made in a cavity.

FIG. 6 is a drawing showing a longitudinal cross section of the casting device with molten metal being poured in the cavity.

FIG. 7 is a drawing showing a longitudinal cross section of the casting device with the upper mold moved up and separating from a lower mold.

FIG. 8 is a drawing showing a longitudinal cross section of a piston base material taken out from the cavity.

FIG. 9 is a sectional view taken along a A-A line of FIG. 10, showing a state in which the friction-resistant ring is held by a holding mechanism according to the present embodiment.

FIG. 10 is a bottom view showing the state in which the friction-resistant ring is held by the holding mechanism according to the present embodiment.

FIG. 11A is a perspective view showing a main part of a holding pin according to the present embodiment. FIG. 11B is a bottom view of the holding pin.

FIG. 12 is a sectional view taken along a B-B line of

FIG. 13, showing a state in which the friction-resistant ring is held by a holding mechanism according to a second embodiment of the present invention.

FIG. 13 is a bottom view showing the state in which the friction-resistant ring is held by the holding mechanism according to the second embodiment.

FIG. 14A is a perspective view showing a main part of a holding pin according to the second embodiment. FIG. 14B is a bottom view of the holding pin.

FIG. 15 is a sectional view taken along a C-C line of

FIG. 16, showing a state in which the friction-resistant ring is held by a holding mechanism according to a third embodiment of the present invention.

FIG. 16 is a bottom view showing the state in which the friction-resistant ring is held by the holding mechanism according to the third embodiment.

FIG. 17A is a perspective view showing a main part of a holding pin according to the third embodiment. FIG. 17B is a bottom view of the holding pin.

### EMBODIMENTS FOR CARRYING OUT THE INVENTION

Embodiments of a production device of a piston for an internal combustion engine and a piston production method by the piston production device according to the present invention will be explained with reference to the drawings. Here, the piston in the embodiments is applied to a reciprocating diesel engine.

### First Embodiment

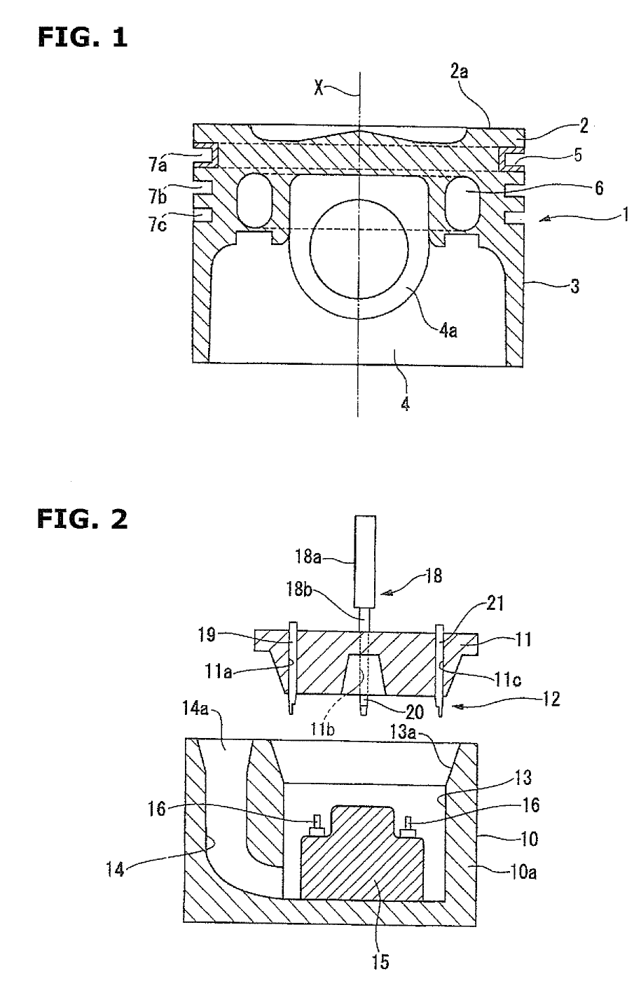

A piston 1 is formed as an integral component by casting with the whole piston being base material made of AC8A Al—Si based aluminium alloy. As shown in FIG. 1, the piston 1 is substantially cylindrical in shape. The piston 1 has a crown portion 2 defining a combustion chamber on and above a crown surface 2a, a pair of arc-shaped thrust-side and counter-thrust-side skirt portions 3 formed integrally with a lower end outer peripheral edge of the crown portion 2 and a pair of apron portions 4 each of which is connected to both side ends in a circumferential direction of each skirt portions 3 through the respective connecting components. Pin boss portions 4a to support both ends of a piston pin (not shown) are formed integrally with the apron portions 4.

The crown portion 2 is shaped into a relatively thick disk, and has a recessed portion whose cross section is a substantially inverted letter M and which defines the combustion chamber on and above the crown surface 2a. As shown in the drawings, the crown portion 2 is formed into a large diameter shape immediately after being taken out of an after-mentioned casting mold, and a protrusion (not shown) formed by riser or feeder head is formed integrally with the crown surface 2a on the crown surface 2a. These protrusion and large diameter outer peripheral portion are machined such as cutting and grinding (or polishing) afterwards according to a design criterion, and piston ring grooves to hold three piston rings such as a pressure ring and an oil ring are formed on an outer peripheral surface of the piston 1.

Further, a friction-resistant ring 5 is buried or embedded in the crown portion 2. An annular hollow portion 6 to circulate cooling oil inside the crown portion 2 is formed at an inner circumferential side of the friction-resistant ring 5.

The friction-resistant ring 5 is a ring to form the piston ring groove that holds the uppermost pressure ring after the grinding (or the polishing) of the outer peripheral portion of the crown portion 2 as mentioned above. The friction-resistant ring 5 is formed as a single component by Ni-resist cast iron, and has a ring shape.

The annular hollow portion 6 is coaxially aligned with a center axis X of the friction-resistant ring 5 and the piston 1, as shown in FIG. 1. Further, the annular hollow portion 6 is located so as to be spaced a predetermined gap width length (a predetermined distance) from an inner circumferential surface of the friction-resistant ring 5 toward a radially inner side, and located at an inner side with respect to the inner circumferential surface of the friction-resistant ring 5.

It is desirable that the friction-resistant ring 5 and the annular hollow portion 6 be located in as close a position as possible to an inner upper end side of the crown portion 2 which is close to the combustion chamber in order for the friction-resistant ring 5 and the cooling oil in the annular hollow portion 6 to efficiently perform heat exchange with the outside by absorbing high heat of the combustion chamber.

Next, the device for casting the piston 1 will be explained.

This casting device is configured as shown in FIGS. 2 to 7. The casting device mainly has a lower mold 10 that is a main mold fixed to a base (not shown) and having in the middle thereof a protruding part 15 that is a core, an upper mold 11 that is a movable mold provided in an upper side position of the lower mold 10 and being movable in up and down directions, a holding mechanism 12 that holds the friction-resistant ring 5 while working in concert with the upper mold 11 and a control unit (not shown) that is a control mechanism controlling up-and-down movements and moving timings etc. of the upper mold 11 and the holding mechanism 12.

The lower mold 10 has a structure in which the protruding part 15 is formed from a plurality of mold members that can be dismantled in a predetermined direction, a cavity 13 for molding the piston is formed in the substantially middle inside the lower mold 10, and a pouring port 14 whose cross section is a substantially L-shape is formed at a side portion inside the lower mold 10.

The cavity 13 is defined by an outer peripheral side partition wall 10a and the substantially cylindrical protruding part 15 that molds an inside of the piston 1 while molding the skirt portions 3 and the apron portions 4 of the piston 1 at a lower side in the middle of the lower mold 10. The cavity 13 and the protruding part 15 are formed so that the crown portion 2 of the piston 1 faces to an upper side in a gravity direction when casting the piston 1 through the protruding part 15.

The protruding part 15 is provided, at an upper end outer peripheral portion thereof, with a plurality of supporting protrusions 16 that protrude in a substantially vertical direction. Each of the supporting protrusions 16 previously supports and fixes, by an upper end thereof, a salt core 17 whose cross section is an oval shape for forming the annular hollow portion 6 in the cavity 13.

The upper mold 11 is supported by a movable mechanism 18 so that the upper mold 11 opens and closes an upper end opening 13a of the cavity 13 from above. A lower portion of the upper mold 11 is formed into a shape to mold the crown surface 2a and the recessed portion of the crown portion 2. The movable mechanism 18 is formed by, for instance, a hydraulic cylinder. The movable mechanism 18 has a cylinder 18a secured to a hanging base (not shown) and a piston rod 18b expanding and contracting (moving up and down) through a piston in the cylinder 18a. Atop end of this piston rod 18b is fixed to an upper middle portion of the upper mold 11.

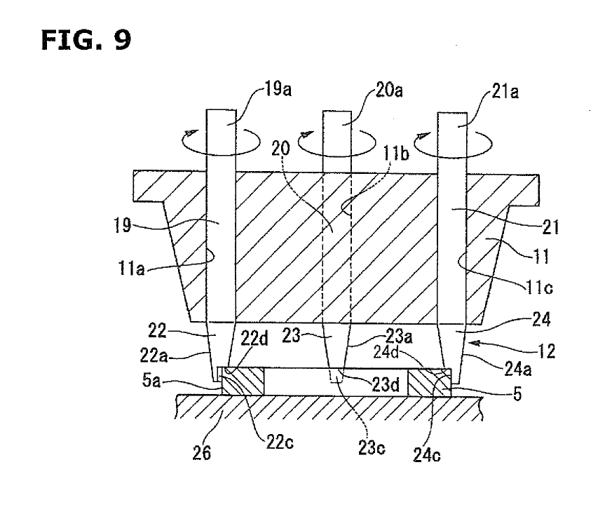

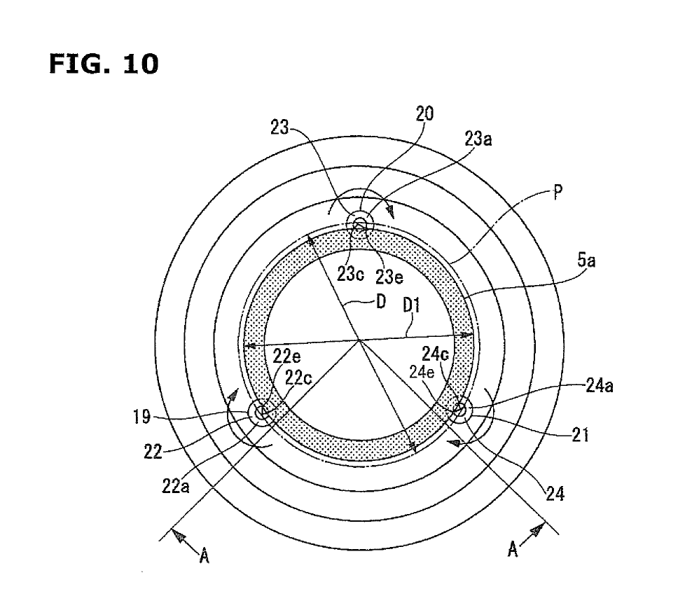

The holding mechanism 12 has, as shown in FIGS. 9 and 10, three holding pins 19, 20 and 21 rotatably supported by the upper mold 11 and a rotation drive unit (not shown) rotating each of the holding pins 19, 20 and 21 about their pin axes by a predetermined angle in forward and reverse directions in synchronization with each other.

Each of the holding pins 19, 20 and 21 is formed into a rod shape whose horizontally-cut cross section is a circular shape and which has a certain length in up and down directions. Further, the holding pins 19, 20 and 21 are inserted into and disposed in three holding holes 11a, 11b and 11c respectively that are formed by penetrating the upper mold 11 in the up and down directions in each 120° degree position in a circumferential direction of an outer circumferential portion of the upper mold 11. Each movement in the up and down directions of the holding pins 19, 20 and 21 is restrained by the rotation drive unit.

These three holding pins 19, 20 and 21 are driven and rotate simultaneously by upper end portions 19a to 21a, which protrude upward from upper end openings of the respective holding holes 11a to 11c, being clamped by the rotation drive unit. Further, top end portions 22 to 24, as holding portions, of the holding pins 19 to 21, which protrude downward (toward the cavity) from the respective holding holes 11a to 11c, respectively have outer peripheral surfaces 22a to 24a that are tapered surfaces. In addition, a tip end side of each of the top end portions 22 to 24 is shaped into a half-cut shape by being cut away (or cut out) along its axial direction.

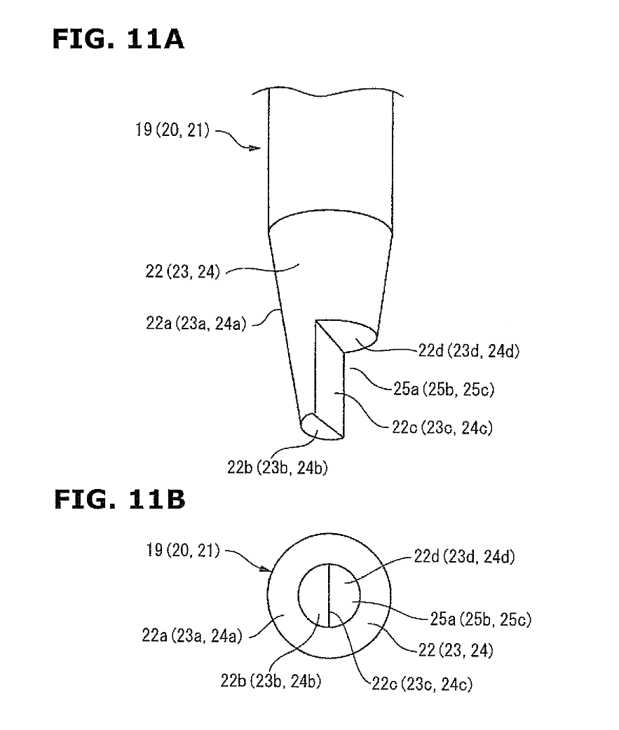

That is, as shown in FIGS. 11A and 11B, the top end portions 22 to 24 has cutting portions 25a to 25c that are formed by cutting the tip end sides of the top end portions 22 to 24 in half from tip end edges 22b to 24b along their axial directions so as to have a half-cut L-shape. Therefore, at the tip end sides of the top end portions 22 to 24, by the cutting portions 25a to 25c, rectangular holding surfaces 22c to 24c extending along the respective axial directions and stepped surfaces 22d to 24d extending from upper edges of the holding surfaces 22c to 24c along a horizontal radial direction are formed.

The holding surfaces 22c to 24c are formed into a flat rectangular shape, while the stepped surfaces 22d to 24d are formed into a substantially semi-circular shape.

In a state in which the holding pins 19 to 21 are inserted into and supported by the holding holes 11a to 11c of the upper mold 11 respectively, as shown in FIGS. 9 and 10, positioning of each of the holding surfaces 22c to 24c is made so as to be located in a slightly outer position with respect to an outer circumferential surface 5a of the friction-resistant ring 5. Each of the stepped surfaces 22d to 24d is opposed to an upper surface of the friction-resistant ring 5 with a slight gap appearing between the stepped surfaces 22d to 24d and the upper surface of the friction-resistant ring 5. That is, the holding pins 19 to 21 are set so that a diameter length D of a circular path P formed by connecting loci of the holding surfaces 22c to 24c in a state in which each of the holding surfaces 22c to 24c is open with respect to the friction-resistant ring 5 (i.e. each of the holding surfaces 22c to 24c does not hold the friction-resistant ring 5) is slightly greater than a diameter length D1 of the outer circumferential surface 5a of the friction-resistant ring 5.

The holding pins 19 to 21 are supported by and in the holding holes 11a to 11c of the upper mold 11 respectively all the time.

The rotation drive unit is formed from an electric motor, a speed reducer that reduces a rotation speed of the electric motor and a transmission unit that transmits a force of the rotation reduced by the speed reducer to each of the holding pins 19 to 21 through the upper end portions 19a to 21a.

The control unit performs a supply and discharge control of hydraulic pressure to the cylinder 18a by controlling open/closure of an electromagnetic valve (not shown) provided in a hydraulic circuit of the movable mechanism 18. With this control, the piston rod 18b expands and contracts (moves up and down), and thereby controlling an up-and-down movement position of the upper mold 11. Here, upon the control of the up-and-down movement position of the upper mold 11, a timing of downward movement of the upper mold 11 etc. are controlled through the piston rod 18b according to a pouring amount of molten metal Q into the cavity 13. Further, by outputting a control current to an electric motor of the holding mechanism 12, a rotation angle of the holding pins 19 to 21 is controlled in the same direction and with the same rotation torque.

Then, to hold the friction-resistant ring 5 by the holding mechanism 12, as shown in FIG. 9, first the friction-resistant ring 5 is previously mounted on amount base 26 while making positioning of the friction-resistant ring 5 before being held by the holding mechanism 12.

Next, the upper mold 11 having been located above the friction-resistant ring 5 is moved down by the movable mechanism 18, and positioning of the holding surfaces 22c to 24c of the holding pins 19 to 21 is made so that the holding surfaces 22c to 24c face the outer circumferential surface 5a of the friction-resistant ring 5 with a predetermined gap appearing between the holding surfaces 22c to 24c and the outer circumferential surface 5a. After that, when the holding pins 19 to 21 are rotated in synchronization with each other in arrow directions shown in FIGS. 9 and 10 by the rotation drive unit, one end edges 22e to 24e of the holding surfaces 22c to 24c are press-fitted to the outer circumferential surface 5a of the friction-resistant ring 5 with a predetermined rotation torque. With these contacts, the friction-resistant ring 5 is surely held by three points of the one end edges 22e to 24e. From this state, the upper mold 11 moves up by the movable mechanism 18 or by a moving mechanism (not shown), and the friction-resistant ring 5 also moves up and is located in a predetermined upper side position of the lower mold 10. Or alternatively, the mount base 26 is removed, and the upper mold 11 is located in a predetermined upper side position of the lower mold 10 together with the friction-resistant ring 5.

### [Production Process of Piston]

Next, procedure of processes for producing (manufacturing, or casting) the piston 1 using the casting device will be explained. As a casting method by this casting device, so-called gravity field method is employed.

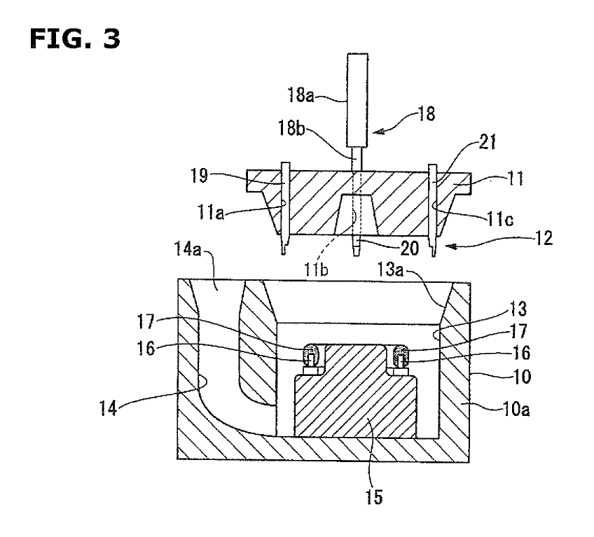

First, as shown in FIG. 3, the salt core 17 is supported by and fixed to each upper end of the supporting protrusions 16 in the cavity 13 (a first step, a salt core fixing process). This salt core 17 is preheated to approx. 720° C.

On the other hand, the friction-resistant ring 5 is a ring that is taken out after being immersed in 760° C. temperature AC3A molten alumina for 10 minutes, and thus a surface treatment layer of AC3A is formed on the entire surface of the friction-resistant ring 5. This friction-resistant ring 5 is held by the three holding pins 19 to 21 of the upper mold 11 in the manner mentioned above, and positioning of the friction-resistant ring 5 is made so that the friction-resistant ring 5 is located in the upper side position of the lower mold 10 (a second step, a holding process).

Here, the reason why the high purity AC3A alumina surface layer is previously formed on the friction-resistant ring 5 is because the AC3A alumina has good reaction with iron then adhesion of the poured molten metal Q to the friction-resistant ring 5 can be increased.

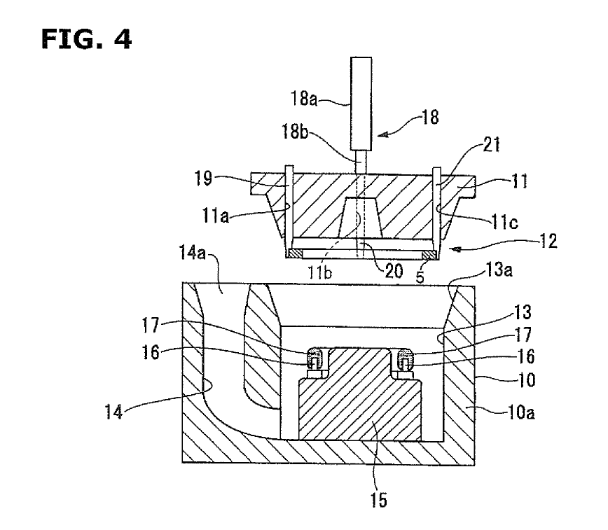

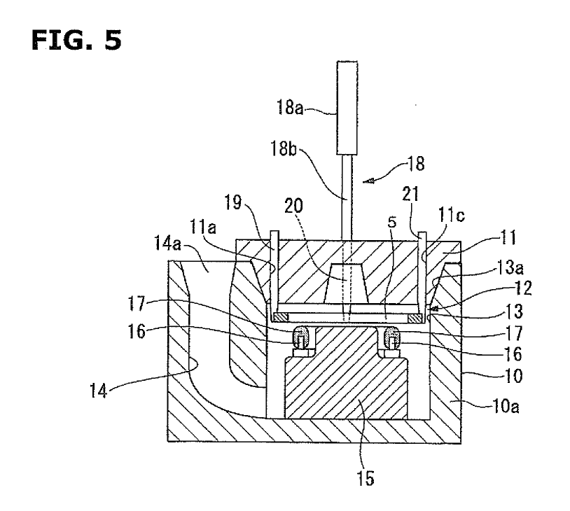

Subsequently, as shown in FIG. 4, in the manner mentioned above, the friction-resistant ring 5 is previously held by the holding mechanism 12. Further, from this state, as shown in FIG. 5, the upper mold 11 is moved down to a predetermined position by the movable mechanism 18 and is clamped (a third step, a clamping process). With this, the upper end opening 13a of the cavity 13 is closed and sealed, and the friction-resistant ring 5 is placed in a predetermined upper side position of the salt core 17.

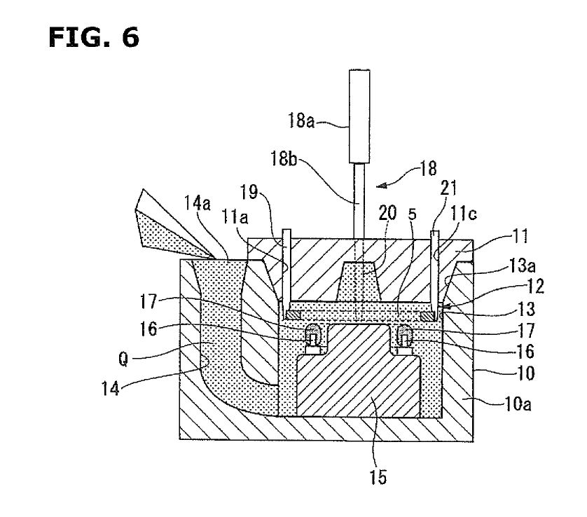

Afterwards, as shown in FIG. 6, approx. 720° C. temperature AC8A (aluminium alloy) molten metal Q is poured into the cavity 13 from a funnel-shaped opening end 14a of the pouring port 14 until the salt core 17 and the whole friction-resistant ring 5 are immersed in the molten metal Q. Pouring of the molten metal Q is finished when the cavity 13 is filled with the molten metal Q. With this, the friction-resistant ring 5 is connected or adheres to the piston base material (a fourth step, an adhering process).

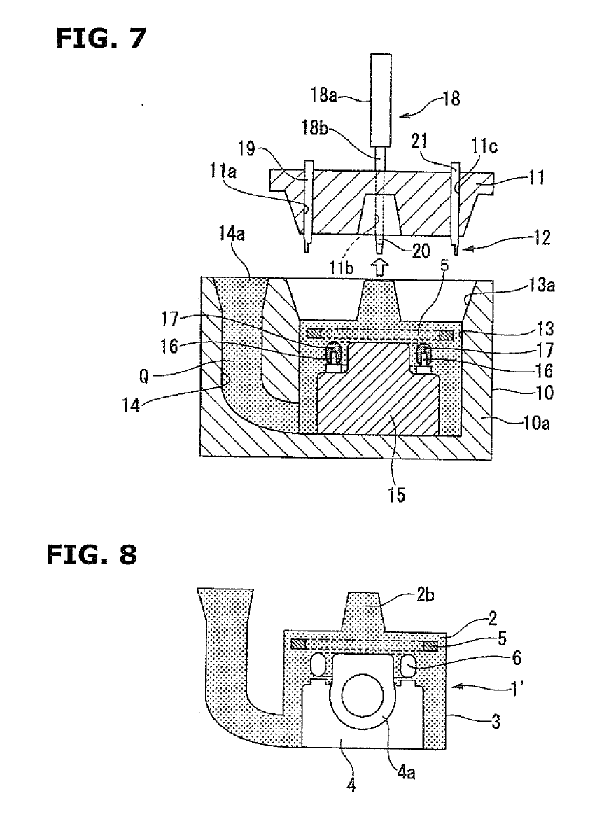

Then, after the molten metal Q is cooled and solidified, as shown in FIG. 7, by moving up the upper mold 11 by the movable mechanism 18, the upper mold 11 is separated or released from the lower mold 10 (a fifth step, a releasing process).

Subsequently, as shown in FIG. 8, mold members of the lower mold 10 are dismantled, and a piston base material 1′ is taken out from the cavity 13 (a sixth step, a taking-out process).

Next, the piston base material 1′ is formed into a predetermined shape by machining such as grinding and polishing. Further, by pouring water to an inside of the salt core 17, the salt core 17 is dissolved, and the annular hollow portion 6 shown in FIG. 6 is formed (a seventh step).

Although a casting work is completed by a series of these processes, after this casting work, as a finishing work, by grinding and polishing an outside shape of the piston base material 1′, the piston ring grooves are formed on the outer circumference etc. of the friction-resistant ring 5.

In the present embodiment, the friction-resistant ring 5 before being accommodated in the cavity 13 can be held surely and firmly by rotating the three holding pins 19 to 21 of the holding mechanism 12. Therefore, since stable holding of the friction-resistant ring 5 can be possible, it is possible to avoid a situation where the friction-resistant ring 5 inclines with the holding pin being a center or falls off due to poor engagement which arises in the related art piston production device.

Further, in the present embodiment, the three holding pins 19 to 21 are arranged in 120° degree positions in the circumferential direction of the upper mold 11 through the respective holding holes 11a to 11c. Therefore, when the outer circumferential surface 5a of the friction-resistant ring 5 is held by the end edges 22e to 24e of the holding surfaces 22c to 24c, positioning of the friction-resistant ring 5 in a radial direction is automatically made. Thus, there is no need to provide an extra radial direction positioning mechanism, and increase in cost of the casting device can be suppressed.

In addition, as the holding mechanism 12 holding the friction-resistant ring 5, a simple mechanism only mainly using the three holding pins 19 to 21 supported by the upper mold 11 is employed. Producing or manufacturing work of the holding mechanism 12 can therefore be facilitated.

Furthermore, in the present embodiment, since the holding mechanism 12 is provided at the upper mold 11 and no mechanism is provided at the lower mold 10, a structure of the casting device can be simplified.

Moreover, since the friction-resistant ring 5 is held at the upper mold 11 and the salt core 17, which is hard to support, is previously placed and fixed in the cavity 13, efficiency in casting work is improved.

Further, since the friction-resistant ring 5 can be stably held by the holding mechanism 12, when pouring the molten metal Q into the cavity 13, an occurrence of the inclination of the friction-resistant ring 5 is suppressed, and good flowing or running of the molten metal Q around the friction-resistant ring 5 can be obtained. An occurrence of Misrun and cold shut can therefore be suppressed.

Additionally, each of the top end portions 22 to 24 of the holding pins 19 to 21 has the tapered shape. Therefore, in the releasing process of the upper mold 11 as shown in FIG. 7, when the holding pins 19 to 21 having held the friction-resistant ring 5 move up while releasing the friction-resistant ring 5 together with the upper mold 11, the tapered outer peripheral surfaces 22a to 24a of the top end portions 22 to 24 can be easily pulled out or drawn out from the solidified molten metal Q. Efficiency in casting work is thus improved.

### Second Embodiment

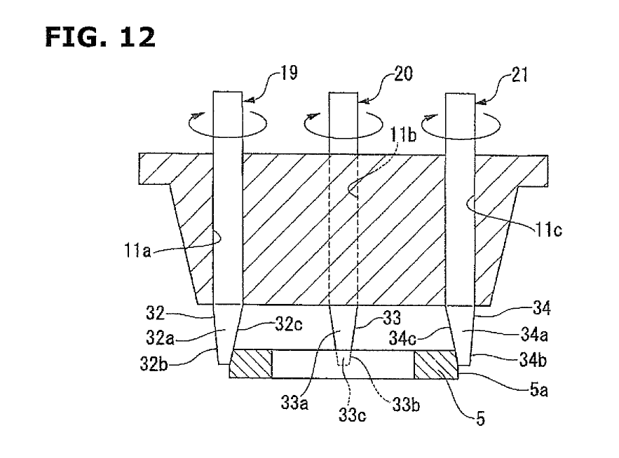

FIGS. 12 to 14 show a holding mechanism 12 of the production device of a second embodiment. Although the upper mold 11 is the same as that of the first embodiment, a structure of top end portions (holding portions) 32 to 34 of the three holding pins 19 to 21 of the holding mechanism 12 is different.

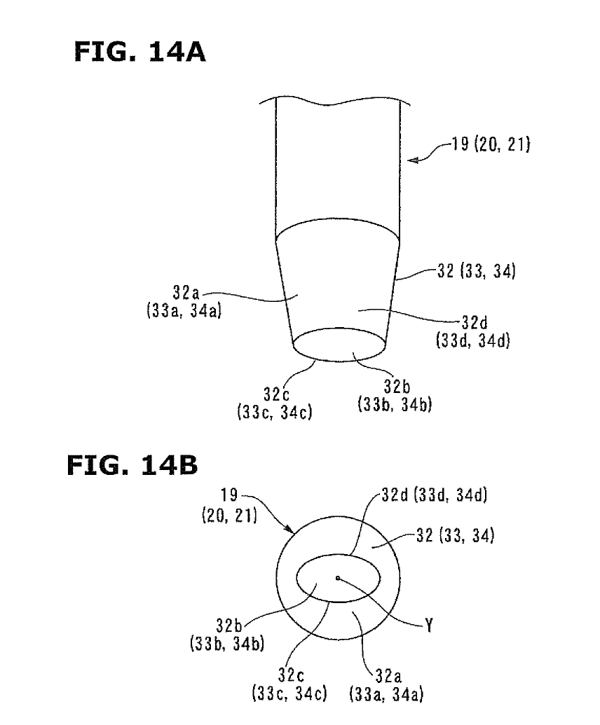

That is, as shown in FIG. 14, the holding pins 19 to 21 are formed so that outer peripheral surfaces 32a to 34a of the top end portions 32 to 34 are shaped into a tapered surface, and each of the holding pins 19 to 21 has a tip end whose horizontally-cut cross section is an oval shape. Each oval shape in the cross section of the outer peripheral surfaces 32a to 34a of the top end portions 32 to 34 bulges or expands in a radial direction with an axis Y of each of the holding pins 19 to 21 being a center. Therefore, one side surfaces 32c to 34c and the other side surfaces 32d to 34d of the outer peripheral surfaces 32a to 34a have a symmetrical arc shape.

The other structure or configuration, such as the rotation drive of the holding pins 19 to 21 by the control unit, is the same as that of the first embodiment.

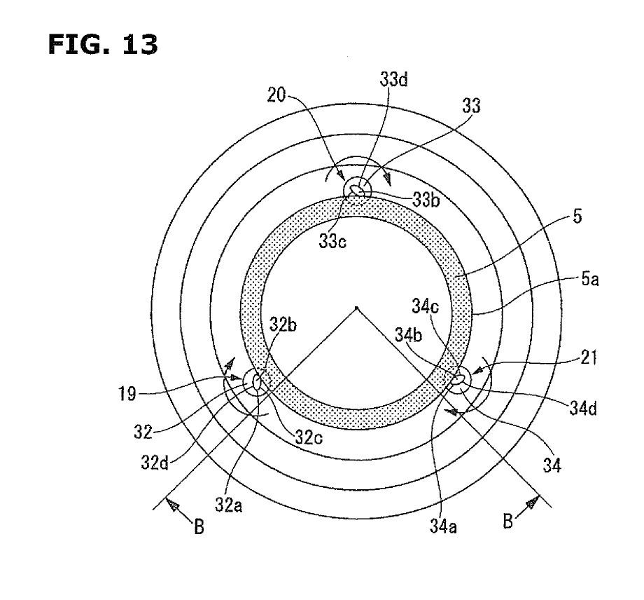

Therefore, as explained above, to hold the friction-resistant ring 5 by the holding mechanism 12, the upper mold 11 having been located above the friction-resistant ring 5 mounted on the mount base 26 is moved down by the movable mechanism 18, and positioning of, for instance, the one side surfaces 32c to 34c of the outer peripheral surfaces 32a to 34a of the top end portions 32 to 34 is made so that the one side surfaces 32c to 34c face the outer circumferential surface 5a of the friction-resistant ring 5 with a predetermined gap appearing between the one side surfaces 32c to 34c and the outer circumferential surface 5a. After that, when the holding pins 19 to 21 are rotated in synchronization with each other in arrow directions shown in FIGS. 12 and 13 by the rotation drive unit, one end surfaces of the one side surfaces 32c to 34c are press-fitted to the outer circumferential surface 5a of the friction-resistant ring 5 with a predetermined rotation torque. With these contacts, the friction-resistant ring 5 is surely held by three points of the one end surfaces of the one side surfaces 32c to 34c. From this state, the upper mold 11 moves up by the movable mechanism 18 or by the moving mechanism (not shown), and the friction-resistant ring 5 also moves up and is located in a predetermined upper side position of the lower mold 10. Or alternatively, the mount base 26 is removed, and the upper mold 11 is located in a predetermined upper side position of the lower mold 10 together with the friction-resistant ring 5.

Subsequently, in the same manner as the above explanation, the upper mold 11 is moved down by the movable mechanism 18 and held in a predetermined position in the cavity 13 while making positioning of the upper mold 11 in the up and down directions, and the casting through each process is done, then the piston base material 1′ is formed.

Accordingly, also in the present embodiment, the same effects as those of the first embodiment, such as the stable and firm holding of the friction-resistant ring 5 by the holding mechanism 12, can be obtained.

### Third Embodiment

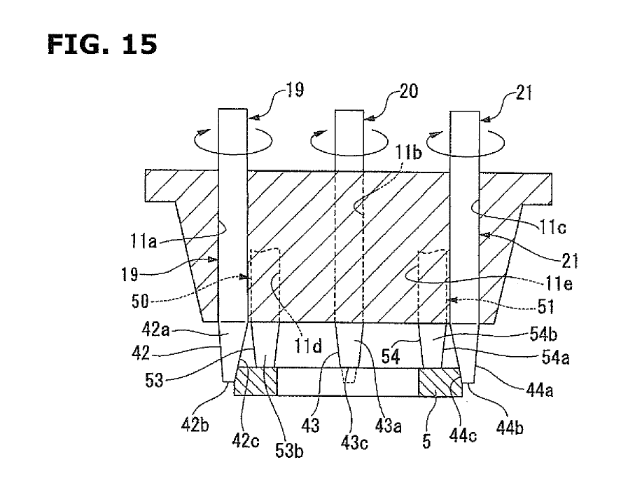

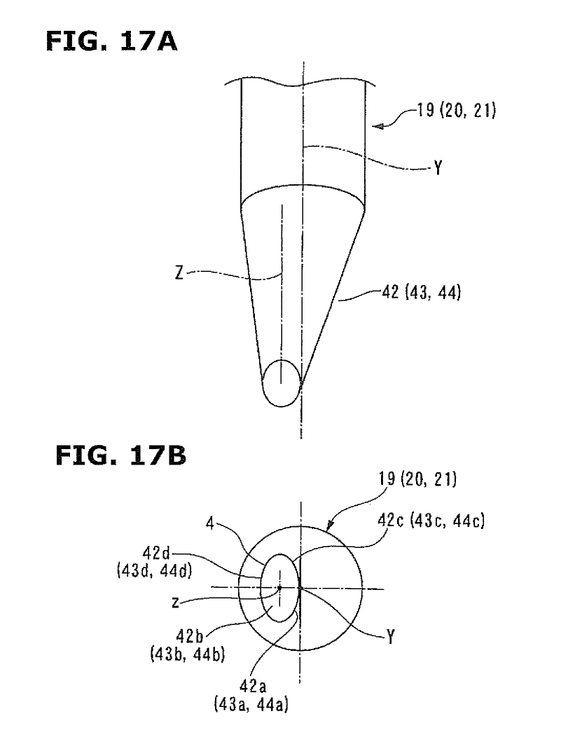

FIGS. 15 to 17 show a holding mechanism 12 of the production device of a third embodiment. A structure of top end portions (holding portions) 42 to 44 of the three holding pins 19 to 21 of the holding mechanism 12 is different from that of the above embodiments.

That is, the holding pins 19 to 21 are formed so that outer peripheral surfaces 42a to 44a of the top end portions 42 to 44 are shaped into a tapered surface, and each of the holding pins 19 to 21 has a tip end whose horizontally-cut cross section is an oval shape, which are the same as the second embodiment. However, an axis Z of each of the top end portions 42 to 44 is eccentric to an axis Y of a body of each of the holding pins 19 to 21 in a radial direction. Each oval shape in the cross section of the outer peripheral surfaces 42a to 44a of the top end portions 42 to 44 bulges or expands in the radial direction with the eccentric axis Z of each of the top end portions 42 to 44 being a center. Further, one side surfaces 42c to 44c and the other side surfaces 42d to 44d of the outer peripheral surfaces 42a to 44a have a symmetrical arc shape. Moreover, the holding pins 19 to 21 are formed so that a circumferential direction center position of each of the one side surfaces 42c to 44c is positioned on the axis Y of each of the holding pins 19 to 21.

Here, the shape in the cross section of each of the top end portions 42 to 44 of the holding pins 19 to 21 could be, for instance, a circular shape as long as the axis Z is eccentric to the axis Y of the body of each of the holding pins 19 to 21 in the radial direction. In this case, since the shape in the cross section is the circular shape, the holding pins 19 to 21 can be easily pulled out, and quality of the holding pins 19 to 21 is improved.

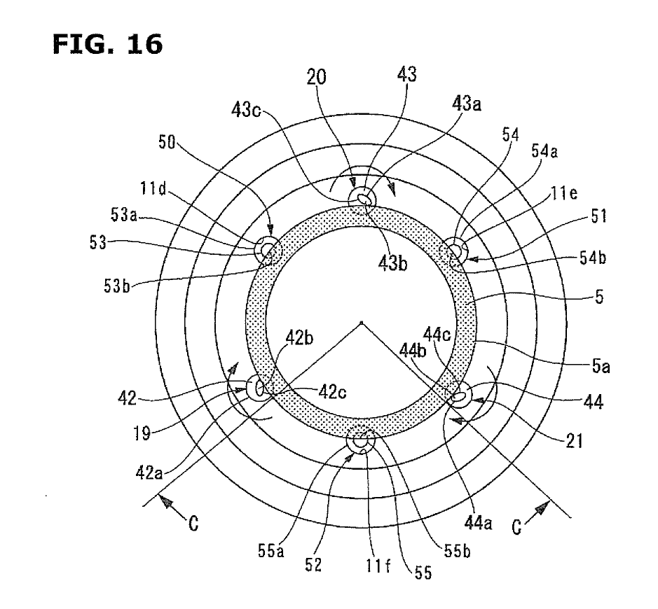

Further, as shown in FIGS. 15 and 16, the upper mold 11 has three fixing holes 11d to 11f formed circumferentially between the holding holes 11a to 11c, i.e. in each 120° degree position in a circumferential direction of the upper mold 11. Then, three positioning pins 50, 51 and 52 for making positioning of the friction-resistant ring 5 in axial and radial directions are press-fixed to the fixing holes 11d to 11f.

The positioning pins 50 to 52 are formed so that outer peripheral surfaces 53a to 55a of top end portions 53 to 55 of the positioning pins 50 to 52 are shaped into a tapered shape, and inner side surfaces 53b to 55b from an upper end edge to a tip end edge of the top end portions 53 to 55 are shaped into an arc shape. Each of the inner side surfaces 53b to 55b is formed so that its radius of curvature is the substantially same as that of the outer circumferential surface 5a of the friction-resistant ring 5. More specifically, a diameter D of a circular path formed by connecting loci of the inner side surfaces 53b to 55b is set to be slightly greater than the diameter length D1 of the outer circumferential surface 5a of the friction-resistant ring 5 so that positioning in the radial direction of the friction-resistant ring 5 can be made by three points of the inner side surfaces 53b to 55b.

The other structure or configuration of the positioning pins 50 to 52 is the same as that of the holding pin 19 to 21 of the first embodiment. Thus, a further explanation of the positioning pins 50 to 52 will be omitted here.

The other structure or configuration, such as the rotation drive of the holding pins 19 to 21 by the control unit, is the same as that of the above embodiments.

Therefore, as explained above, to hold the friction-resistant ring 5 by the holding mechanism 12, when the upper mold 11 having been located above the friction-resistant ring 5 mounted on the mount base 26 is moved down by the movable mechanism 18, while the inner side surfaces 53b to 55b of the positioning pins 50 to 52 contact the outer circumferential surface 5a of the friction-resistant ring 5 in 120° degree positions in the circumferential direction, stepped surfaces of the positioning pins 50 to 52 contact an upper surface close to the outer circumferential surface 5a of the friction-resistant ring 5. With these contacts, positioning of the friction-resistant ring 5 in radial and axial directions is made.

At the same time, the holding pins 19 to 21 are positioned so that, for instance, the one side surfaces 42c to 44c of the outer peripheral surfaces 42a to 44a of the top end portions 42 to 44 of the holding pins 19 to 21 face the outer circumferential surface 5a of the friction-resistant ring 5 with a predetermined gap appearing between the one side surfaces 42c to 44c and the outer circumferential surface 5a.

After that, when the holding pins 19 to 21 are rotated in synchronization with each other in arrow directions shown in FIGS. 15 and 16 by the rotation drive unit, one end surfaces of the one side surfaces 42c to 44c are press-fitted to the outer circumferential surface 5a of the friction-resistant ring 5 with a predetermined rotation torque. With these contacts, the friction-resistant ring 5 is surely held by three points of the one end surfaces of the one side surfaces 42c to 44c. From this state, the upper mold 11 moves up by the movable mechanism 18 or by the moving mechanism (not shown), and the friction-resistant ring 5 also moves up and is located in a predetermined upper side position of the lower mold 10. Or alternatively, the mount base 26 is removed, and the upper mold 11 is located in a predetermined upper side position of the lower mold 10 together with the friction-resistant ring 5.

Subsequently, in the same manner as the above explanation, the upper mold 11 is moved down by the movable mechanism 18 and held in a predetermined position in the cavity 13 while making positioning of the upper mold 11 in the up and down directions, and the casting through each process is done, then the piston base material 1′ is formed.

Accordingly, also in the present embodiment, the same effects as those of the above embodiments, such as the stable and firm holding of the friction-resistant ring 5 by the holding mechanism 12, can be obtained.

Further, in the present embodiment, since positioning of the friction-resistant ring 5 in the radial and axial directions is made by the three positioning pins 50 to 52, accuracy of positioning of the friction-resistant ring 5 is improved. An even better holding of the friction-resistant ring 5 by the holding pins 19 to 21 can therefore be obtained, and the friction-resistant ring 5 is stably held in the cavity 13.

The present invention is not limited to the structure or configuration of the above embodiments. For instance, two holding pins and three positioning pins could be provided, then the friction-resistant ring 5 is held by the two holding pins while making positioning of the friction-resistant ring 5 using the three positioning pins.

Further, the shape of the top end portion of the holding pin could be formed into a different shape from that of the above embodiments. For instance, the shape in cross section could be a square or a triangle.

Furthermore, the structures of the lower mold 10 and the upper mold 11 can be freely changed according to design and size of the piston 1.

Moreover, the piston 1 could be applied to not only the diesel engine but also the gasoline engine.

1. A production device of a piston for an internal combustion engine, the piston having a friction-resistant ring embedded in a crown portion of the piston for forming a piston ring groove, the production device comprising:
a main mold provided thereinside with a cavity for forming the piston and having an opening of the cavity;
a movable mold provided movably so as to open and close the opening of the cavity; and
a plurality of holding pins protruding from the movable mold toward the cavity, and wherein
at least one of the plurality of holding pins is provided rotatably on an axis of the one of the holding pins with respect to the movable mold, and the one of the holding pins has at a top end portion thereof a holding portion that contacts and holds the friction-resistant ring by a rotation angle position of the one of the holding pins.

2. The production device of the piston for the internal combustion engine as claimed in claim 1, wherein:
a shape in horizontally-cut cross section of the holding portion is non-perfect circle.

3. The production device of the piston for the internal combustion engine as claimed in claim 2, wherein:
the holding portion is formed into a tapered shape so that an area of the shape in the horizontally-cut cross section of the holding portion is gradually decreased toward a tip end edge of the holding portion.

4. The production device of the piston for the internal combustion engine as claimed in claim 3, wherein:
the holding pin has a main pin portion rotatably supported in the movable mold and the holding portion formed integrally with a top end portion of the main pin portion,
a rotation mechanism rotating the holding pin having the main pin portion and the holding portion by a predetermined angle in an axial direction of the holding pin is provided in the production device, and
the holding portion is provided with a stepped portion formed by cutting in the vicinity of a boundary with the main pin portion.

5. The production device of the piston for the internal combustion engine as claimed in claim 4, wherein:
the holding portion is shaped into a tapered shape from a main pin portion side toward a top end of the holding portion.

6. The production device of the piston for the internal combustion engine as claimed in claim 4, wherein:
the stepped portion between the main pin portion and the holding portion is shaped into a flat surface.

7. The production device of the piston for the internal combustion engine as claimed in claim 2, wherein:
the shape in the horizontally-cut cross section of the holding portion is a semi-circular shape.

8. The production device of the piston for the internal combustion engine as claimed in claim 2, wherein:
the shape in the horizontally-cut cross section of the holding portion is an oval shape.

9. The production device of the piston for the internal combustion engine as claimed in claim 2, wherein:
all of the plurality of holding pins are rotatably provided, and
when holding the friction-resistant ring, all the plurality of holding pins rotate in synchronization with each other.

10. The production device of the piston for the internal combustion engine as claimed in claim 1, wherein:
the holding portion is provided so that an axis of the holding portion is eccentric to a rotation axis of the holding pin in a radial direction.

11. The production device of the piston for the internal combustion engine as claimed in claim 10, wherein:
the holding portion has a circular shape in horizontally-cut cross section which is eccentric to a rotation axis of the holding portion.

12. The production device of the piston for the internal combustion engine as claimed in claim 1, further comprising:
a positioning mechanism that makes positioning in a horizontal direction of the friction-resistant ring when holding the friction-resistant ring by the holding pins.

13. The production device of the piston for the internal combustion engine as claimed in claim 12, wherein:
the positioning mechanism has positioning pins that contact a plurality of points on one end surface of the friction-resistant ring from a direction perpendicular to the one end surface.

14. A method of producing a piston for an internal combustion engine, the piston having a friction-resistant ring embedded in a crown portion of the piston for forming a piston ring groove, the method comprising:
holding the friction-resistant ring by rotating, by a predetermined angle, a plurality of holding pins rotatably provided at a movable mold and by bringing an outer edge of a holding portion formed at a top end portion of each of the holding pins into contact with the friction-resistant ring;
clamping the movable mold to a main mold having thereinside a cavity for forming the piston after the friction-resistant ring having been held at the movable mold by the holding pins is placed in a predetermined position in the cavity;
integrally adhering the friction-resistant ring to a piston base material by pouring molten metal into the cavity and by filling the cavity with the molten metal;
separating the movable mold from the main mold after the molten metal is cooled and solidified; and
taking out the piston base material to which the friction-resistant ring adheres from the cavity after the movable mold is separated from the main mold.

15. The method of producing the piston for the internal combustion engine as claimed in claim 14, wherein:
a shape in horizontally-cut cross section of the holding portion is formed into non-perfect circle, or is formed so as to be eccentric to a rotation axis of the holding pin.
